(19) United States
(12) Patent Application Publication
(10) Pub. No.: US 2025/0347957 A1
(43) Pub. Date: Nov. 13, 2025

(54) VEHICLE DISPLAY SYSTEM AND OPERATION METHOD THEREOF

(71) Applicants: InnoLux Corporation, Miao-Li County (TW); CARUX TECHNOLOGY PTE. LTD., APERIA (SG)

(72) Inventors: Yu-Chia HUANG, Miao-Li County (TW); Tsung-Han TSAI, Miao-Li County (TW); Li-Wei SUNG, Tainan (Tainan Science Park) (TW)

(21) Appl. No.: 19/172,997

(22) Filed: Apr. 8, 2025

(30) Foreign Application Priority Data
May 7, 2024 (CN) 202410555171.4

(51) Int. Cl. G02F 1/1335; G02F 1/13; G02F 1/133

(52) U.S. Cl. CPC G02F 1/133626; G02F 1/1323; G02F 1/13318

(57) ABSTRACT

A vehicle display system is provided. The vehicle display system includes a display for displaying images, a directional ambient-light sensor for detecting light intensities in different directions, and a processor electrically connected to the display and the directional ambient-light sensor. An operation method of a vehicle display system is also provided.

### CROSS REFERENCE TO RELATED APPLICATIONS

This application claims priority of China Patent Application No. 202410555171.4, filed on May 7, 2024, the entirety of which is incorporated by reference herein.

### BACKGROUND

### Technical Field

The present disclosure relates to a vehicle display system, and in particular it relates to a vehicle display system that can accurately detect the intensity of light incident into a driver's sight and adjust image visibility.

### Description of the Related Art

Ambient-light intensity in a car can affect the driver's ability to read a display or to assess road conditions. A traditional method of reducing strong glare in a car only uses an ambient-light sensor to detect the total intensity of ambient light at the location of the sensor to make adjustments to a display screen.

However, the ambient light that actually affects the driver is not all the light intensity at the location of the ambient-light sensor, but the light intensity that is incident into the driver's line of sight. In particular, strong light from specific directions will affect driving safety.

### SUMMARY

In accordance with one embodiment of the present disclosure, a vehicle display system is provided. The vehicle display system includes a display, a directional ambient-light sensor and a processor. The display is used for displaying images. The directional ambient-light sensor is used for detecting light intensities in different directions. The processor is electrically connected to the display and the directional ambient-light sensor.

In accordance with one embodiment of the present disclosure, an operation method of a vehicle display system is provided. The operation method includes the following steps. A directional ambient-light sensor is used to detect light intensities in different directions. A processor is used to receive the light intensities in different directions, which are provided by the directional ambient-light sensor, to generate multiple original light intensities. The original light intensities are weighted to obtain multiple weighted light intensities. The weighted light intensities, or the sum of the weighted light intensities, are compared with corresponding thresholds. When one of the weighted light intensities or the sum of the weighted light intensities is greater than or equal to the corresponding threshold, a display image is adjusted to a first state. In another embodiment, the original light intensities are directly compared with the corresponding thresholds. The processor does not weight the original light intensities. When one of the original light intensities is greater than or equal to the corresponding threshold, the display image is adjusted to the first state. The first state has a visual contrast which is greater than that of the original state.

In accordance with one embodiment of the present disclosure, a vehicle display system is provided. The vehicle display system includes a display, a plurality of directional ambient-light sensors and a processor. The display is used for displaying images. The directional ambient-light sensors surround the display and are used for detecting light intensities in different directions. The processor is electrically connected to the display and the directional ambient-light sensors.

### BRIEF DESCRIPTION OF THE DRAWINGS

The disclosure can be more fully understood from the following detailed description when read with the accompanying figures. It is worth noting that in accordance with standard practice in the industry, various features are not drawn to scale. In fact, the dimensions of the various features may be arbitrarily increased or reduced for clarity of discussion.

FIG. 1 shows a simple schematic diagram of a vehicle display system in accordance with one embodiment of the present disclosure;

FIG. 2A shows a top view of some components in a vehicle display system in accordance with one embodiment of the present disclosure;

FIG. 2B shows a cross-sectional view of FIG. 2A;

FIG. 3A shows a cross-sectional view of some components in a vehicle display system in accordance with one embodiment of the present disclosure;

FIG. 3B shows a cross-sectional view of some components in a vehicle display system in accordance with one embodiment of the present disclosure;

FIG. 4 shows a flow chart of an operation method of a vehicle display system in accordance with one embodiment of the present disclosure;

FIG. 5 shows a flow chart of an operation method of a vehicle display system in accordance with one embodiment of the present disclosure;

FIG. 6A shows a cross-sectional view of a display module in accordance with one embodiment of the present disclosure;

FIG. 6B shows a cross-sectional view of a display module in accordance with one embodiment of the present disclosure;

FIG. 7 shows a cross-sectional view of a self-luminous display in accordance with one embodiment of the present disclosure;

FIG. 8 shows a flow chart of an operation method of a vehicle display system in accordance with one embodiment of the present disclosure;

FIG. 9 shows a flow chart of an operation method of a vehicle display system in accordance with one embodiment of the present disclosure;

FIG. 10 shows a schematic diagram of an operation method of a vehicle display system in accordance with one embodiment of the present disclosure; and

FIG. 11 shows a top view of some components in a vehicle display system in accordance with one embodiment of the present disclosure.

### DETAILED DESCRIPTION

The following description lists various embodiments of this disclosure to introduce the basic concepts of this case, and is not intended to limit the content of this case. The actual scope of the invention should be defined according to the scope of the patent application. Reference will now be made in detail to exemplary embodiments of the present disclosure, examples of which are illustrated in the accompanying drawings. Whenever possible, the same reference numbers are used in the drawings and descriptions to refer to the same or similar parts.

Throughout this disclosure and the appended claims, certain words are used to refer to specific components. Those skilled in the art will appreciate that the device manufacturers may refer to the same components by different names. This article is not intended to differentiate between components that have the same functionality but different names. In the following description and claims, the words “comprise”, “include” and “contain” are open-ended words, and therefore they should be interpreted to mean “comprising but not limited to . . . ”

The directional terms mentioned in this article, such as: “up”, “down”, “front”, “back”, “left”, “right”, etc., are only for reference to the directions of the accompanying drawings. The directional terms in this paper are used to define the relative positions of the illustrated components, and are not intended to limit the disclosure. In the drawings, each figure illustrates the general features of methods, structures, and/or materials used in particular embodiments. However, these drawings should not be interpreted as defining or limiting the scope or nature encompassed by these embodiments. For example, the relative sizes, thicknesses, and locations of the different layers, regions, and/or structures may be shrunken or enlarged for clarity.

In this paper, one structure (or layer, or component, or substrate) located on/above another structure (or layer, or component, or substrate) may mean that the two structures are directly connected, or the two structures are adjacent but not directly connected. Indirect connection means that there is at least one intermediary structure (or intermediary layer, intermediary component, intermediary substrate, intermediary spacer) between two structures. The lower surface of upper structure is adjacent to or directly connected to the upper surface of the intermediary structure. The upper surface of the lower structure is adjacent to or directly connected to the lower surface of the intermediate structure. The intermediary structure may be a single-layer/multi-layer physical structure, or a non-physical structure (there is no limit). In this disclosure, when a structure is disposed “on” another structure, it may mean that the structure is “directly” on the other structure, or that the structure is “indirectly” on the other structure (that is, between the two structures, at least one other structure is also sandwiched.

The terms “about”, “substantially” or “roughly” are generally interpreted to mean an offset within 20% of a given value or range, or to mean an offset within 5%, 3%, 2%, 1% or 0.5% of a given value or range.

Furthermore, any two numerical values or directions used for comparison may have certain errors. If the first value is equal to the second value, it implies that there may be a tolerable error difference about 10%. If a first direction is perpendicular or approximately perpendicular to a second direction, the angle between the first direction and the second direction may be 80-100 degrees. If the first direction is parallel or substantially parallel to the second direction, the angle between the first direction and the second direction may be 0-10 degrees.

The ordinal numbers used in the description and claims, such as “first”, “second”, etc., are used for identification between components. They do not imply the existence of a component with the previous ordinal number. Such ordinal numbers do not represent the order of the components, or the order of manufacturing procedures. These ordinal numbers are used to clearly distinguish two components with the same naming. The ordinal numbers given to the components in the claims may be different from the ordinal numbers given to the components in the description. Accordingly, the first component in the description may be the second component in the claim.

In the disclosure, descriptions like “a given range is from a first value to a second value” or “a given range falls within the range between a first value and a second value” indicate that the given range includes the first value, the second value, and other values between them.

It should be understood that in the exemplary embodiments of the disclosure, the depth, thickness, width, or height of each component, or the spacing or distance between components may be measured by an optical microscope (OM), a scanning electron microscope (SEM), a film thickness measurement device (α-step), or an ellipsometer. In some exemplary embodiments, a cross-sectional structural image of a component may be captured by a scanning electron microscope, which also measures the depth, thickness, width or height of each component, or the spacing or distance between components.

According to the embodiments of the disclosure, an electronic device may include a display device, an assembled device, a touch display, a sensing device, an antenna device, a packaging device, a curved display, or a free shape display, but it is not limited thereto. The electronic device may use display media like liquid crystal, light-emitting diodes, fluorescence, phosphor, or any other suitable display media, or a combination of the above, but it is not limited thereto. A display device may be a non-self-luminous display device or a self-luminous display device. An electronic device may include an electronic element. An electronic element may be a passive element or an active element, for example, a capacitor, a resistor, an inductor, a diode, a driving element, or a transistor, etc. A diode may include a light-emitting diode (LED) or a photodiode. A light-emitting diode (LED) may include an organic light-emitting diode (OLED), a mini LED, a micro LED, or a quantum-dot LED, but it is not limited thereto. An assembled device may be an assembled display device, but it is not limited thereto. An antenna device may be a liquid-crystal type antenna device or a varactor-diode type antenna device, but it is not limited thereto. A packaging device can be used in wafer-level packaging (WLP) technology or panel-level packaging (WLP) technology, for example, chip-first or RDL-first technology. It should be noted that the electronic device can be any combination of the above, but it is not limited thereto. In addition, the electronic device may be a bendable or flexible electronic device. In addition, the shape of the electronic device may be a rectangular shape, a circular shape, a polygonal shape, a shape with curved edges, or other suitable shapes. The electronic device may have peripheral systems, for example, a driving system, a control system, a light source system, a structural system, etc., to support the display device or assembled device.

It should be noted that in the embodiments shown below, features in several different embodiments may be replaced, reorganized, or combined without departing from the spirit of the present disclosure. Features in various embodiments may be combined as long as they do not violate the spirit of the disclosure or conflict with each other.

Unless otherwise defined, all terms (including technical and scientific terms) used herein have the same meaning as commonly understood by one of ordinary skill in the art. It is understood that these terms, such as those defined in commonly used dictionaries, should be interpreted to have a meaning consistent with the relevant technology and the background or context of the present disclosure, and should not be interpreted in an idealized or overly formal manner (unless otherwise defined).

In addition, the word “adjacent” in the description and claims, for example, is used to describe mutual proximity and does not necessarily mean that they are in contact with each other.

In addition, descriptions such as “when . . . ” or “at the moment” in this disclosure means a period of time, from prior to the event to later than the event. It is not limited to events happen just at the same time, which are announced in advance here. Furthermore, “disposed on” and other similar descriptions in this disclosure indicate the relative positions of objects, and do not limit to a physical contact between the objects, unless there are special limitations. Furthermore, when the present disclosure describe multiple functions, and the word “or” is used in listing the functions, it means that the functions can exist independently, but it does not exclude that multiple functions may exist at the same time.

In addition, words such as “electrically connected” or “coupled” in the description and claims not only refer to a direct electrical connection between the different objects, but also refer to an indirect electrical connection between the different objects. Electrical connection includes direct electrical connection, indirect electrical connection, or wireless communication between the different objects.

In this present disclosure, when “or” is used as a connective word between multiple elements, unless otherwise stated, the expressions of “and” and “or” are included.

In the present disclosure, when a certain element is disposed on another element, it means that the certain element may be disposed on a certain side of another element, such as but not limited to above, below, left, right, front, or back side. The two elements may not directly contact to each other.

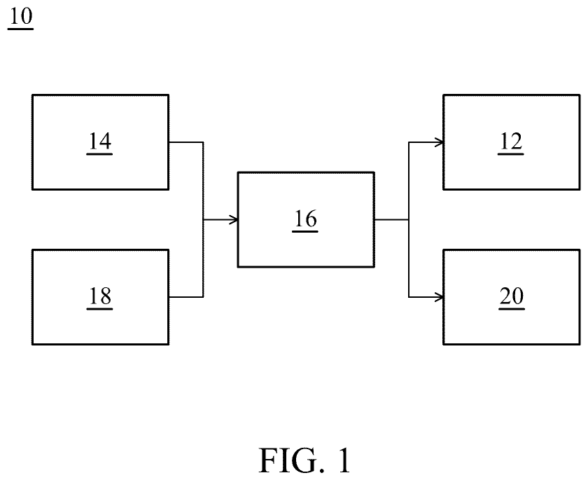

Referring to FIG. 1, in accordance with one embodiment of the present disclosure, a vehicle display system 10 is provided. FIG. 1 is the simple schematic diagram of the vehicle display system 10.

As shown in FIG. 1, the vehicle display system 10 includes a display 12, a directional ambient-light sensor 14 and a processor 16. The display 12 is used for displaying images. The directional ambient-light sensor 14 is used for detecting light intensities in different directions. The processor 16 is electrically connected to the display 12 and the directional ambient-light sensor 14. For example, the processor 16 receives the light intensities in different directions provided from the directional ambient light sensor 14, and after appropriate processing, transmits the signals to the display 12 to adjust the visual contrast of the image. In some embodiments, the directional ambient-light sensor 14 includes CCD (Charge Coupled Device), COMS (Complementary Metal-Oxide Semiconductor) or/and other suitable photosensitive components.

In accordance with some embodiments, the vehicle display system 10 further includes a driver monitoring system 18 that can obtain a driver's sight direction in real time through, for example, an eye tracking sensor or a gesture sensor. The signals of the driver's sight direction provided by the driver monitoring system 18 and the signals of the light intensities in different directions provided by the directional ambient-light sensor 14 are transmitted to the processor 16 for signal processing and interpretation.

In accordance with some embodiments, the vehicle display system 10 further includes a smart window system 20 for adjusting window transparency. The processor 16 also transmits relevant signals to the smart window system 20 to adjust window transparency.

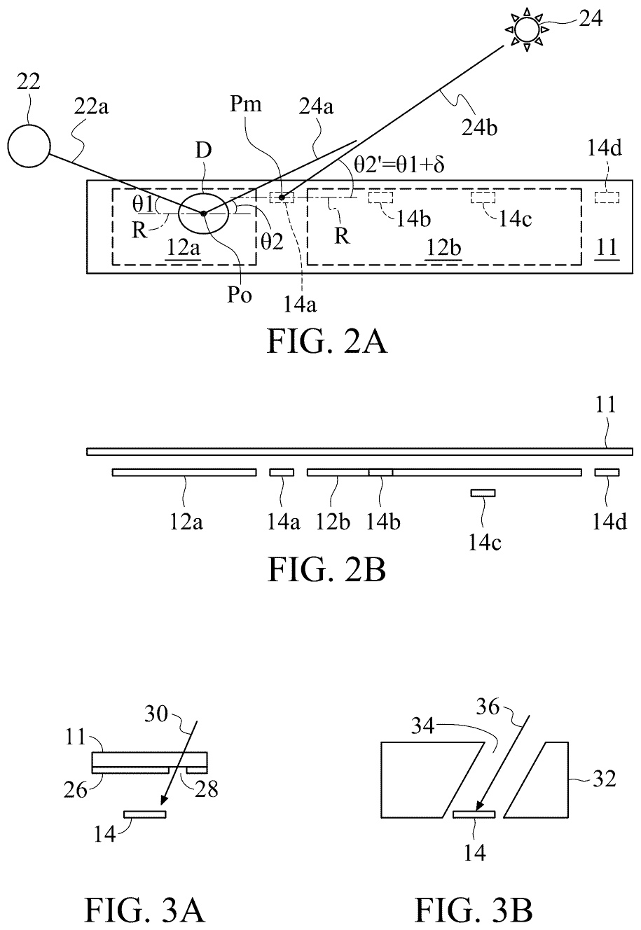

The relative positional relationship between the directional ambient-light sensor and the display is described below with reference to FIGS. 2A and 2B. FIG. 2A is a top view of some components in the vehicle display system. FIG. 2B is a cross-sectional view of FIG. 2A.

As shown in FIGS. 2A and 2B, a first display 12a, a second display 12b and a plurality of directional ambient-light sensors (for example, a first directional ambient-light sensor 14a, a second directional ambient-light sensor 14b, a third directional ambient-light sensor 14c, and a fourth directional ambient-light sensor 14d) are provided below a glass cover 11. In accordance with some embodiments, the directional ambient-light sensor is disposed adjacent to the side of the display, or disposed inside, above, or below the display, but it is not limited thereto. For example, as shown in FIG. 2A, the first directional ambient-light sensor 14a is disposed between the first display 12a and the second display 12b, adjacent to the sides of the first display 12a and the second display 12b. The second directional ambient-light sensor 14b is disposed inside the second display 12b. The third directional ambient-light sensor 14c is disposed below the second display 12b. The fourth directional ambient-light sensor 14d is disposed adjacent to the side of the second display 12b.

According to FIG. 2A, it is further explained that, for example, relative to a display area D on the first display 12a, a sight direction 22a of a driver 22 and a first incident direction 24a (having a specific direction) of strong glare 24 basically have a mirror-symmetrical relationship. That is, the angle θ1 between the sight direction 22a of the driver 22 and the reflective surface R is equal to the angle θ2 between the first incident direction 24a of the strong glare 24 and the reflective surface R. In addition, in accordance with some embodiments, when there is a positional deviation between a driver's observation point and a sensor's measurement point, a correction value can be considered when evaluating the angle of the incident direction of the strong glare. For example, when there is a positional deviation between the observation point Po (i.e. the driver's 22 sight position on the first display 12a) of the driver 22 and the measurement point Pm (i.e. the location of the first directional ambient-light sensor 14a) of the first directional ambient-light sensor 14a, when evaluating the angle of the incident direction of the strong glare 24, a correction value δ can be considered, for example, θ2′-θ1+δ, and the corrected second incident direction 24b of the strong glare 24 is obtained, where θ2′ is the angle between the second incident direction 24b of the strong glare 24 and the reflective surface R.

The types of the directional ambient-light sensors are described below.

In accordance with some embodiments, the directional ambient-light sensors receive light from all directions and can detect the light intensity corresponding to the light in each direction.

In accordance with some embodiments, the directional ambient-light sensors receive light from a specific direction, and the received light intensity is the light intensity corresponding to that specific direction. At this time, the directional ambient-light sensors can detect the light intensity corresponding to the light in the specific direction. The structure of this type of the directional ambient-light sensor is shown in FIGS. 3A and 3B. FIGS. 3A and 3B are cross-sectional views of some components in the vehicle display system.

Referring to FIG. 3A, a shielding layer 26 is provided below the glass cover 11. The shielding layer 26 overlaps the directional ambient-light sensor 14 in a vertical direction. That is, in a front viewing direction, the shielding layer 26 completely blocks the directional ambient-light sensor 14. In the figure, the shielding layer 26 is formed with an opening 28 in an oblique direction relative to the directional ambient-light sensor 14. The directional ambient-light sensor 14 receives the light 30 from a specific direction through the arrangement of the opening 28. In accordance with some embodiments, the shielding layer 26 includes, for example, ink, a metal layer, or an opaque material, but it is not limited thereto.

Referring to FIG. 3B, an oblique collimation structure 32 is provided around the directional ambient-light sensor 14 to form an oblique opening 34. The directional ambient-light sensor 14 receives the light 36 from a specific direction through the arrangement of the oblique opening 34.

In accordance with some embodiments, the directional ambient-light sensor is installed on a rotatable base (not shown). The base mechanically rotates to drive the directional ambient-light sensor on it to receive light in a specific direction and detect the light intensity corresponding to the light in the specific direction.

In accordance with some embodiments, light in a specific direction can be an incident light that easily disturbs a driver. For example, it can be glare caused by ambient light incident into the display and reflected to human eyes. More specifically, it can be strong ambient light that is incident into the display and reflected to within 120° of the viewing angle of the human eye, causing trouble to the user while driving, but it is not limited thereto.

Referring to FIG. 1, the operation method of the vehicle display system 10 will be further described.

In accordance with some embodiments, as shown in FIG. 1, first, the directional ambient-light sensor 14 is used to detect light intensities in different directions. Next, the processor 16 is used to receive the light intensities in different directions provided by the directional ambient-light sensor 14 and perform numerical processing. For example, received light intensities in different directions are used as original light intensities, and the original light intensities are weighted to obtain weighted light intensities. Next, the weighted light intensities or the sum of the weighted light intensities are compared with corresponding thresholds. When one of the weighted light intensities or the sum of the weighted light intensities is greater than or equal to the corresponding threshold, the signals that require image adjustment are transmitted to the display 12. Afterwards, the visual contrast of the image is adjusted through the display 12.

In accordance with some embodiments, the detailed process executed by the processor 16 is described below with a weighted table 1 (Table 1 below).

TABLE 1

| Polar | Plane | Original | | Weighted | | |
|---|---|---|---|---|---|---|
| angle | angle | light | | light | | Adjust or |
| (θ) | (φ) | intensities | Weighted | intensities | Threshold | not |
| 0 | 180 | 400 | 0.1 | 40 | 100 | N |
| 20 | 180 | 500 | 0.1 | 50 | 100 | N |
| 0 | 90 | 300 | 0.2 | 60 | 100 | N |
| 20 | 90 | 100 | 1.0 | 100 | 100 | Y |
| 0 | 0 | 200 | 0.5 | 100 | 100 | Y |
| 20 | 0 | 180 | 1.0 | 180 | 100 | Y |

The polar angle (θ) ranges from greater than or equal to 0 degrees to less than or equal to 90 degrees. The plane angle (φ) ranges from greater than or equal to 0 degrees to less than or equal to 360 degrees. The direction of the incident light can be determined by the polar angle (θ) and the plane angle (φ). For example, in Table 1, for the driver, the incident light with the polar angle (θ) of 0 degrees and the plane angle (φ) of 180 degrees and the incident light with the polar angle (θ) of 20 degrees and the plane angle (φ) of 180 degrees are left-side light. For the driver, the incident light with the polar angle (θ) of 0 degrees and the plane angle (φ) of 90 degrees and the incident light with the polar angle (θ) of 20 degrees and the plane angle (φ) of 90 degrees are upper-side light. For the driver, the incident light with the polar angle (θ) of 0 degrees and the plane angle (φ) of 0 degrees and the incident light with the polar angle (θ) of 20 degrees and the plane angle (φ) of 0 degrees are right-side light. Here, the original light intensities of the left-side light are 400 and 500 respectively. The original light intensities of the upper-side light are 300 and 100 respectively. The original light intensities of the right-side light are 200 and 180 respectively. The weighted proportion in the table is related to the severity of the impact of light on the driver in that direction. For example, after evaluation, the left-side light affects the driver to a lower extent than the upper-side light and the right-side light. Therefore, a lower weighted proportion of 0.1 is given. For the upper-side light and the right-side light, in particular, the upper-side light with the polar angle (θ) of 20 degrees and the plane angle (φ) of 90 degrees and the right-side light with the polar angle (θ) of 20 degrees and the plane angle (φ) of 0 degrees have the greatest impact on the driver. Therefore, a higher weighted proportion of 1.0 is given. Here, the processor increases the weighted proportion for the light intensity in a specific direction (i.e. the direction of the incident light that is likely to interfere with the driver). The weighted light intensities obtained by weighting the original light intensities of the left-side light are 40 and 50 respectively. The weighted light intensities obtained by weighting the original light intensities of the upper-side light are 60 and 100 respectively. The weighted light intensities obtained by weighting the original light intensities of the right-side light are 100 and 180 respectively. The thresholds of light in each direction in Table 1 are set to 100. After comparing the weighted light intensities with the corresponding thresholds, it is found that the weighted light intensities of the upper-side light with the polar angle (θ) of 20 degrees and the plane angle (φ) of 90 degrees, the right-side light with the polar angle (θ) of 0 degrees and the plane angle (φ) of 0 degrees, and the right-side light with the polar angle (θ) of 20 degrees and the plane angle (φ) of 0 degrees are greater than or equal to the corresponding thresholds. This means that the intensities of the incident light in these directions have interfered with the driver's sight, and the visual contrast of the image needs to be further adjusted through the display 12. In the embodiment shown in Table 1, when one of the weighted light intensities is greater than or equal to the corresponding threshold, the signals that require image adjustment are transmitted to the display 12 to adjust the visual contrast of the image.

In accordance with some embodiments, the detailed process executed by the processor 16 is described below with a weighted table 2 (Table 2 below).

TABLE 2

| Polar | Plane | Original | | Weighted | | |
|---|---|---|---|---|---|---|
| angle | angle | light | | light | | Adjust or |
| (θ) | (φ) | intensities | Weighted | intensities | Threshold | not |
| 60 | 180 | 80 | 0.1 | 8 | 100 | N |
| 40 | 180 | 100 | 0.1 | 10 | 100 | N |
| 20 | 180 | 80 | 0.1 | 8 | 100 | N |
| 0 | 0 | 60 | 0.2 | 12 | 100 | N |
| 20 | 0 | 60 | 0.5 | 30 | 100 | N |
| 40 | 0 | 40 | 1.0 | 40 | 100 | N |
| 60 | 0 | 40 | 0.5 | 20 | 100 | N |
| Sum | | | | 128 | 300 | N |

In Table 2, for the driver, the incident light with the polar angle (θ) of 60 degrees and the plane angle (φ) of 180 degrees, the incident light with the polar angle (θ) of 40 degrees and the plane angle (φ) of 180 degrees, and the incident light with the polar angle (θ) of 20 degrees and the plane angle (φ) of 180 degrees are left-side light. For the driver, the incident light with the polar angle (θ) of 0 degrees and the plane angle (φ) of 0 degrees, the incident light with the polar angle (θ) of 20 degrees and the plane angle (φ) of 0 degrees, the incident light with the polar angle (θ) of 40 degrees and the plane angle (φ) of 0 degrees, and the incident light with the polar angle (θ) of 60 degrees and the plane angle (φ) of 0 degrees are right-side light. Here, the original light intensities of the left-side light are 80, 100 and 80 respectively. The original light intensities of the right-side light are 60, 60, 40 and 40 respectively. After evaluation, the left-side light affects the driver to a lower extent than the right-side light. Therefore, a lower weighted proportion of 0.1 is given. For the right-side light, in particular, the right-side light with the polar angle (θ) of 40 degrees and the plane angle (φ) of 0 degrees have the greatest impact on the driver. Therefore, a higher weighted proportion of 1.0 is given. Here, the processor increases the weighted proportion for the light intensity in a specific direction (i.e. the direction of the incident light that is likely to interfere with the driver). The weighted light intensities obtained by weighting the original light intensities of the left-side light are 8, 10 and 8 respectively. The weighted light intensities obtained by weighting the original light intensities of the right-side light are 12, 30, 40 and 20 respectively. The thresholds of light in each direction in Table 2 are set to 100. After comparing the weighted light intensities with the corresponding thresholds, it is found that the weighted light intensity of each light and the sum of the weighted light intensities are both less than the corresponding thresholds. This means that the intensities of the incident light in these directions do not interfere with the driver's sight, and there is no need to further adjust the visual contrast of the image. In the embodiment shown in Table 2, when the weighted light intensities and the sum of the weighted light intensities are both less than the corresponding thresholds, no signals that require image adjustment will be sent to the display 12.

In accordance with some embodiments, the detailed process executed by the processor 16 is described below with a weighted table 3 (Table 3 below).

TABLE 3

| Polar | Plane | Original | | Weighted | | |
|---|---|---|---|---|---|---|
| angle | angle | light | | light | | Adjust or |
| (θ) | (φ) | intensities | Weighted | intensities | Threshold | not |
| 60 | 180 | 400 | 0.1 | 40 | 100 | N |
| 40 | 180 | 500 | 0.1 | 50 | 100 | N |
| 20 | 180 | 400 | 0.1 | 40 | 100 | N |
| 0 | 0 | 300 | 0.2 | 60 | 100 | N |
| 20 | 0 | 100 | 0.5 | 50 | 100 | N |
| 40 | 0 | 50 | 1.0 | 50 | 100 | N |
| 60 | 0 | 40 | 0.5 | 20 | 100 | N |
| Sum | | | | 310 | 300 | Y |

In Table 3, for the driver, the incident light with the polar angle (θ) of 60 degrees and the plane angle (φ) of 180 degrees, the incident light with the polar angle (θ) of 40 degrees and the plane angle (φ) of 180 degrees, and the incident light with the polar angle (θ) of 20 degrees and the plane angle (φ) of 180 degrees are left-side light. For the driver, the incident light with the polar angle (θ) of 0 degrees and the plane angle (φ) of 0 degrees, the incident light with the polar angle (θ) of 20 degrees and the plane angle (φ) of 0 degrees, the incident light with the polar angle (θ) of 40 degrees and the plane angle (φ) of 0 degrees, and the incident light with the polar angle (θ) of 60 degrees and the plane angle (φ) of 0 degrees are right-side light. Here, the original light intensities of the left-side light are 400, 500 and 400 respectively. The original light intensities of the right-side light are 300, 100, 50 and 40 respectively. After evaluation, the left-side light affects the driver to a lower extent than the right-side light. Therefore, a lower weighted proportion of 0.1 is given. For the right-side light, in particular, the right-side light with the polar angle (θ) of 40 degrees and the plane angle (φ) of 0 degrees have the greatest impact on the driver. Therefore, a higher weighted proportion of 1.0 is given. Here, the processor increases the weighted proportion for the light intensity in a specific direction (i.e. the direction of the incident light that is likely to interfere with the driver). The weighted light intensities obtained by weighting the original light intensities of the left-side light are 40, 50 and 40 respectively. The weighted light intensities obtained by weighting the original light intensities of the right-side light are 60, 50, 50 and 20 respectively. The thresholds of light in each direction in Table 3 are set to 100. After comparing the weighted light intensities with the corresponding thresholds, it is found that although the weighted light intensity of each light is less than the corresponding threshold, the sum of the weighted light intensities is greater than the corresponding threshold. This means that although the intensities of the incident light in these directions do not interfere with the driver's sight, the multiplication effect of the light from all directions has reached a level that interferes with the driver's sight, and the visual contrast of the image needs to be further adjusted through the display 12. In the embodiment shown in Table 3, when the sum of the weighted light intensities is greater than or equal to the corresponding threshold, the signals that require image adjustment are transmitted to the display 12 to adjust the visual contrast of the image.

In accordance with some embodiments, as shown in FIG. 1, first, the directional ambient-light sensor 14 is used to detect light intensities in different directions. Next, the processor 16 is used to receive the light intensities in different directions provided by the directional ambient-light sensor 14 and perform numerical processing. For example, received light intensities in different directions are used as original light intensities. At this time, the processor 16 does not weight the original light intensities and directly compares the original light intensities with the corresponding thresholds. When the original light intensities are greater than or equal to the corresponding thresholds, the signals that require image adjustment are transmitted to the display 12. Afterwards, the visual contrast of the image is adjusted through the display 12.

In accordance with some embodiments, the detailed process executed by the processor 16 is described below with a weighted table 4 (Table 4 below).

TABLE 4

| Polar angle | Plane angle | Original light | | Adjust or |
|---|---|---|---|---|
| (θ) | (φ) | intensities | Threshold | not |
| 60 | 180 | 80 | 100 | N |
| 40 | 180 | 80 | 100 | N |
| 20 | 180 | 80 | 100 | N |
| 0 | 0 | 80 | 100 | N |
| 20 | 0 | 80 | 100 | N |
| 40 | 0 | 80 | 50 | Y |
| 60 | 0 | 80 | 100 | N |
| Sum | | 480 | 500 | N |

In Table 4, for the driver, the incident light with the polar angle (θ) of 60 degrees and the plane angle (φ) of 180 degrees, the incident light with the polar angle (θ) of 40 degrees and the plane angle (φ) of 180 degrees, and the incident light with the polar angle (θ) of 20 degrees and the plane angle (φ) of 180 degrees are left-side light. For the driver, the incident light with the polar angle (θ) of 0 degrees and the plane angle (P) of 0 degrees, the incident light with the polar angle (θ) of 20 degrees and the plane angle (φ) of 0 degrees, the incident light with the polar angle (θ) of 40 degrees and the plane angle (φ) of 0 degrees, and the incident light with the polar angle (θ) of 60 degrees and the plane angle (φ) of 0 degrees are right-side light. Here, the original light intensities of the left-side light are 80. The original light intensities of the right-side light are 80. After evaluation, the right-side light with the polar angle (θ) of 40 degrees and the plane angle (φ) of 0 degrees has the greatest impact on the driver. Therefore, the corresponding threshold is lowered. Here, the processor reduces the corresponding threshold for the light intensity in a specific direction (i.e. the direction of the incident light that is most likely to interfere with the driver). In Table 4, the threshold for the right-side light with the polar angle (θ) of 40 degrees and the plane angle (φ) of 0 degrees is set to 50, and the thresholds for light in other directions are set to 100. After directly comparing the original light intensities with the corresponding thresholds, it is found that since the threshold of the right-side light with the polar angle (θ) of 40 degrees and the plane angle (φ) of 0 degrees is reduced to 50, the original light intensity in this direction is greater than the corresponding threshold. This means that the intensity of the incident light in this direction has reached a level that interferes with the driver's sight, and the visual contrast of the image needs to be further adjusted through the display 12. In the embodiment shown in Table 4, when one of the original light intensities is greater than or equal to the corresponding threshold, the signals that require image adjustment are transmitted to the display 12 to adjust the visual contrast of the image.

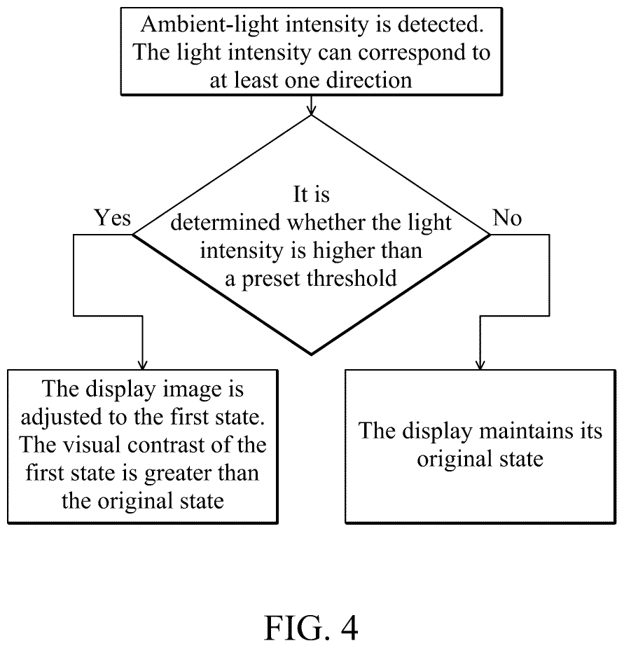

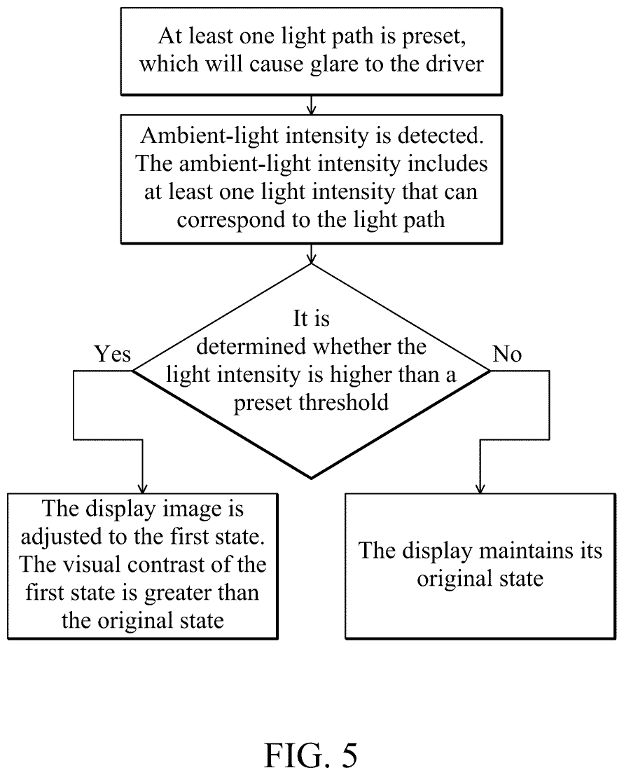

According to the embodiments shown in Tables 1˜4 above, when one of the weighted light intensities or the sum of the weighted light intensities is greater than or equal to the corresponding threshold, or when one of the original light intensities is greater than or equal to the corresponding threshold (in the unweighted case), the signals that require image adjustment are transmitted to the display to adjust the visual contrast of the image. The characteristics of the present disclosure will be illustrated with the flow charts shown in FIGS. 4 and 5.

As shown in FIG. 4, first, ambient-light intensity is detected, and the light intensity can correspond to at least one direction. Afterwards, it is determined whether the light intensity is higher than a preset threshold. If the light intensity is higher than the preset threshold, the display image is adjusted to the first state. The visual contrast of the first state is greater than the original state. If the light intensity is lower than the preset threshold, the display maintains its original state.

As shown in FIG. 5, first, at least one light path is preset, which will cause glare to the driver. Then, ambient-light intensity is detected, and the ambient-light intensity includes at least one light intensity that can correspond to the light path. Then, it is determined whether the light intensity is higher than a preset threshold. If the light intensity is higher than the preset threshold, the display image is adjusted to the first state. The visual contrast of the first state is greater than the original state. If the light intensity is lower than the preset threshold, the display maintains its original state.

The following will illustrate how to adjust the visual contrast of the display image.

Visual contrast, or effective contrast, means the visibility of an image that is actually felt by human eyes. For example, the reflected light reflected from the ambient light to the display surface will be considered. Therefore, the visual contrast can be expressed as [1+ (display light intensity/reflected light intensity)]. In some cases, the resolution, sharpness, and screen update frequency of the display image may affect the visual contrast, but it is not limited thereto. For example, when the visual contrast of the display before adjustment is less than the contrast that human eyes can comfortably watch, the display is adjusted so that the visual contrast after adjustment is greater than the visual contrast before adjustment. The contrast that can be comfortably viewed by human eyes can be the thresholds in the present disclosure, for example, it can be 500, 250, 100, or other contrasts greater than 2. For example, the visual contrast after adjustment can be increased by more than 5% or 10% compared with the visual contrast before adjustment.

Visual contrast is defined as follows:

Visual contrast=1+(display brightness/ambient-light reflection brightness)

Methods for adjusting the visual contrast of the display image include, for example, increasing the brightness of the display, reducing the reflectivity of ambient light, reducing the brightness of ambient light reflected to human eyes, or adjusting the transparency of the car window, but they are not limited thereto.

In accordance with some embodiments, the method of increasing the brightness of the display includes, for example, increasing the global backlight brightness, increasing the local backlight brightness, increasing the brightness of the self-luminous unit, increasing the transparency of the component (such as a dimming shutter) between the display and the backlight, increasing the pulse-width modulation (PWM) driving frequency, or increasing the pulse-amplitude modulation (PAM) driving frequency, but it is not limited thereto.

In accordance with some embodiments, the method of reducing the reflectivity of ambient light includes, for example, increasing the haze of the display surface (for example, attaching a polymer-dispersed liquid-crystal (PDLC) film) or reducing the transparency of components placed on the display (for example, a dimming shutter), but it is not limited thereto.

In accordance with some embodiments, the method of reducing the brightness of ambient light reflected to human eyes includes, for example, adjusting the display surface angle (e.g., set up the mechanics) or moving the display position, but it is not limited thereto.

In accordance with some embodiments, the method of adjusting the transparency of the car window includes, for example, using dimmable glass, curtains, or blackout boards, but it is not limited thereto.

In accordance with some embodiments, the material that can be used as dimmable glass includes, for example, dichroic dye liquid crystal (DDLC), polymer dispersed liquid crystal (PDLC), polymer network liquid crystal (PNLC), cholesteric liquid crystal (CLC), electrochromic (EC) materials, suspended particle device (SPD) chromic materials, electronic ink or photochromic (PC) materials, but it is not limited thereto.

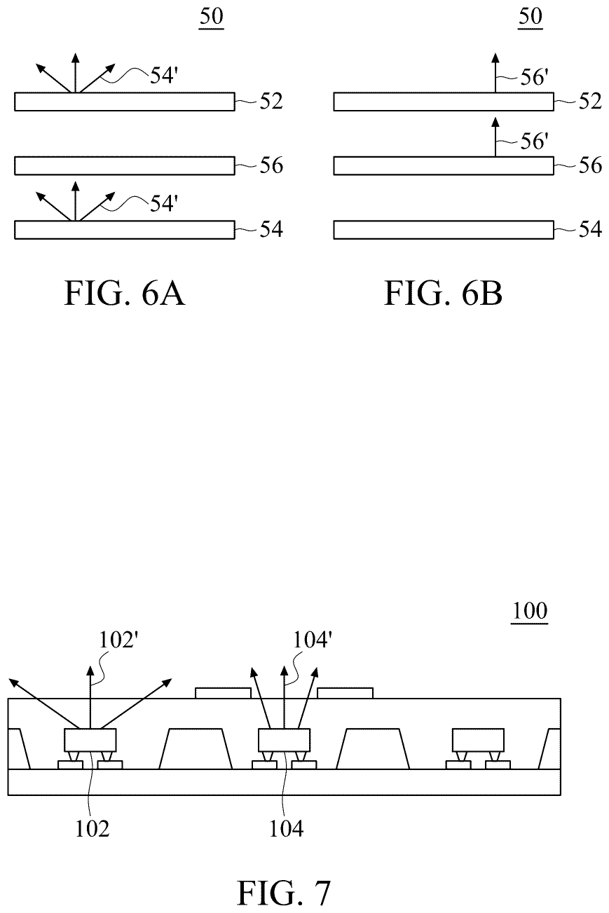

In the following, FIGS. 6A and 6B further illustrate how to increase the brightness of the backlight by setting up the upper and lower backlight sources. FIG. 6A illustrates how to increase global backlight brightness. FIG. 6B illustrates how to increase local backlight brightness. FIGS. 6A and 6B are cross-sectional views of a display module 50.

Referring to FIG. 6A, the display module 50 includes a display 52, a wide-viewing-angle backlight source 54 (which can emit light 54′ in multiple directions), and a narrow-viewing-angle (collimated) backlight source 56 (which can emit light 56′ in a specific direction). The wide-viewing-angle backlight source 54 is disposed below the display 52. The narrow-viewing-angle (collimated) backlight source 56 is disposed between the display 52 and the wide-viewing-angle backlight source 54. When strong glare interferes with the sights of the driver and co-pilot at the same time, the display module 50 can selectively turn on and enhance the wide-viewing-angle backlight source 54 and temporarily turn off the narrow-viewing-angle (collimated) backlight source 56 to increase the global backlight brightness, simultaneously improving the visual contrast of the images viewed by the driver and co-pilot.

Referring to FIG. 6B, when strong glare only interferes with the sight of either the driver or the co-pilot, the display module 50 can selectively turn on and enhance the narrow-viewing-angle (collimated) backlight source 56 and temporarily turn off the wide-viewing-angle backlight source 54 to increase the local backlight brightness. For example, when strong glare only interferes with the co-pilot's sight but not with the driver's sight, in order to maintain the stability of the images viewed by the driver, the display module 50 can selectively turn on and enhance the narrow-viewing-angle (collimated) backlight source 56 (intensify the display light directed to the co-pilot) and temporarily turn off the wide-viewing-angle backlight source 54. Therefore, this can independently improve the visual contrast of the images viewed by the co-pilot without affecting the viewing quality of the driver. In the following, FIG. 7 further illustrates how to achieve the purpose of increasing the brightness of the self-luminous unit through the arrangement of two self-luminous units, including how to increase the global brightness of the self-luminous unit and how to increase the local brightness of the self-luminous unit. FIG. 7 is a cross-sectional view of a self-luminous display 100.

Referring to FIG. 7, the self-luminous display 100 includes a wide-viewing-angle self-luminous unit 102 (which can emit light 102′ in multiple directions) and a narrow-viewing-angle (collimated) self-luminous unit 104 (which can emit light 104′ in a specific direction). When strong glare interferes with the sights of the driver and co-pilot at the same time, the self-luminous display 100 can selectively turn on and enhance the wide-viewing-angle self-luminous unit 102 and temporarily turn off the narrow-viewing-angle (collimated) self-luminous unit 104 to increase the global brightness of the self-luminous unit, simultaneously improving the visual contrast of the images viewed by the driver and co-pilot.

When strong glare only interferes with the sight of either the driver or the co-pilot, the self-luminous display 100 can selectively turn on and enhance the narrow-viewing-angle (collimated) self-luminous unit 104 and temporarily turn off the wide-viewing-angle self-luminous unit 102 to increase the local brightness of the self-luminous unit. For example, when strong glare only interferes with the co-pilot's sight but not with the driver's sight, in order to maintain the stability of the images viewed by the driver, the self-luminous display 100 can selectively turn on and enhance the narrow-viewing-angle (collimated) self-luminous unit 104 (intensify the display light directed to the co-pilot) and temporarily turn off the wide-viewing-angle self-luminous unit 102. Therefore, this can independently improve the visual contrast of the images viewed by the co-pilot without affecting the viewing quality of the driver.

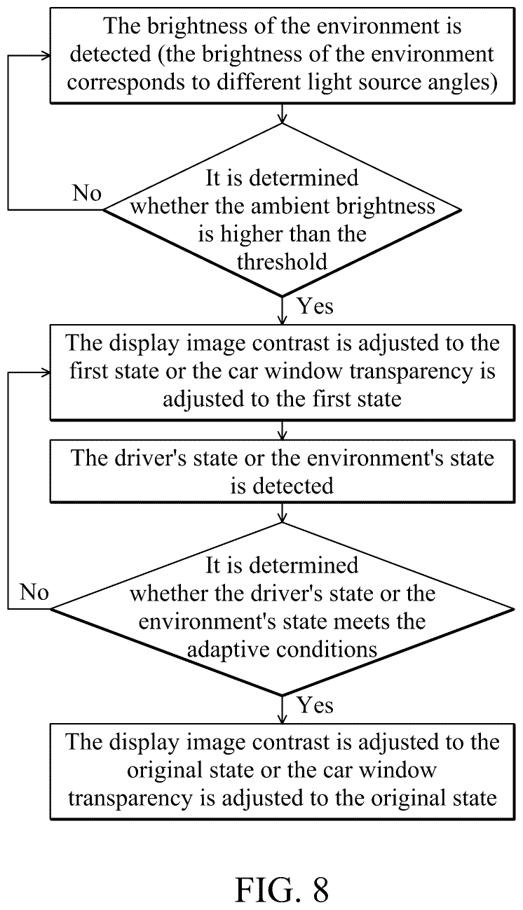

In the following, the flow chart shown in FIG. 8 further illustrates that after the display image is adjusted to the first state due to the ambient brightness higher than the threshold, when the driver's state or the environment's state reaches the adaptive condition, the display may choose to cancel the adjustment of the visual contrast (returning the first state to the original state).

As shown in FIG. 8, first, the brightness of the environment is detected (e.g., the brightness of the environment corresponds to different light source angles). Afterwards, it is determined whether the ambient brightness is higher than the threshold. If the ambient brightness is higher than the threshold, the display image contrast is adjusted to the first state or the car window transparency is adjusted to the first state (e.g., the visual contrast of the first state is greater than the original state). The driver's state or the environment's state is detected at any time. During the process, it is judged whether the driver's state or the environment's state meets the adaptive conditions. In accordance with some embodiments, The adaptive condition includes, for example, the driver's pupil dilation ratio reaching 50% or entering the environment for a preset time (for example, 30 seconds or 1 minute, etc.), but it is not limited thereto. If the driver's state or the environment's state meets the adaptive conditions, the display image contrast is adjusted to the original state or the car window transparency is adjusted to the original state.

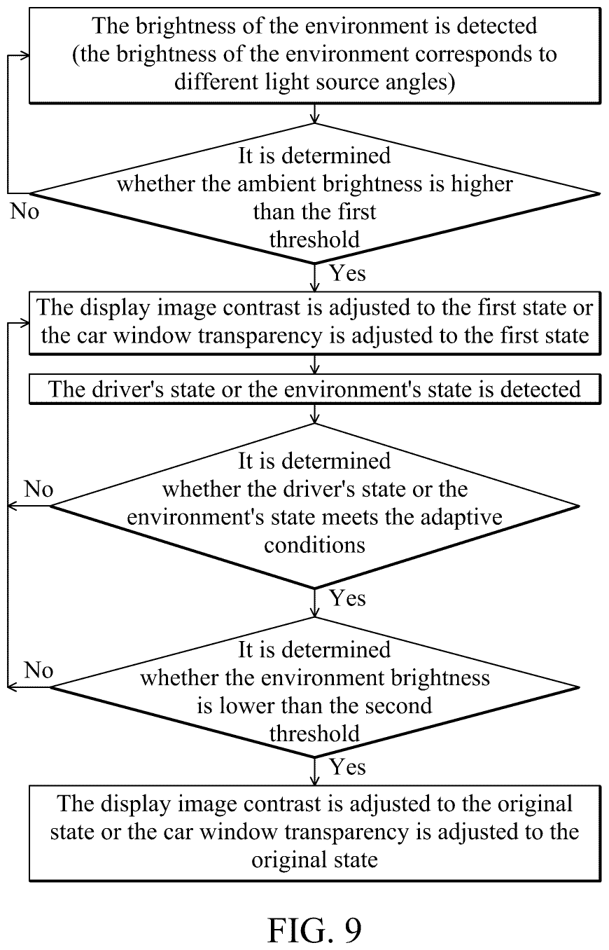

In the following, the flow chart shown in FIG. 9 further illustrates that after the display image is adjusted to the first state due to the ambient brightness higher than the first threshold, when the driver's state or the environment's state reaches the adaptive condition and the environment brightness is lower than the second threshold (for example, since the driver adapts to the environment as time goes by, the second threshold is higher than the first threshold), the display may choose to cancel the adjustment of the visual contrast (returning the first state to the original state).

As shown in FIG. 9, first, the brightness of the environment is detected (e.g., the brightness of the environment corresponds to different light source angles). Afterwards, it is determined whether the ambient brightness is higher than the first threshold. If the ambient brightness is higher than the first threshold, the display image contrast is adjusted to the first state or the car window transparency is adjusted to the first state (e.g., the visual contrast of the first state is greater than the original state). The driver's state or the environment's state is detected at any time. During the process, it is judged whether the driver's state or the environment's state meets the adaptive conditions. In accordance with some embodiments, The adaptive condition includes, for example, the driver's pupil dilation ratio reaching 50% or entering the environment for a preset time (for example, 30 seconds or 1 minute, etc.), but it is not limited thereto. If the driver's state or the environment's state reaches the adaptive condition and the environment brightness begins to fall below the second threshold (for example, since the driver adapts to the environment as time goes by, the second threshold is higher than the first threshold), the display image contrast is adjusted to the original state or the car window transparency is adjusted to the original state.

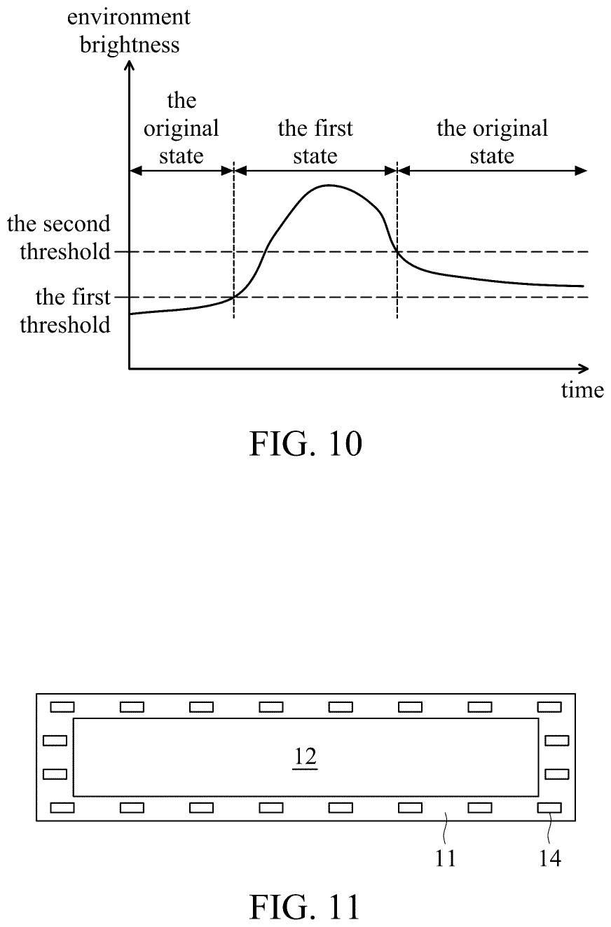

The relationship between the first threshold and the second threshold, and the mutual conversion between the original state and the first state are further described below with reference to FIG. 10.

As shown in FIG. 10, when the ambient brightness is lower than the first threshold, the display image maintains the original state. Once the ambient brightness is higher than the first threshold, the display image contrast is adjusted to the first state or the car window transparency is adjusted to the first state (e.g., the visual contrast of the first state is greater than the original state). When the ambient brightness begins to fall below the set second threshold (for example, since the driver adapts to the environment as time goes by, the second threshold is higher than the first threshold), the display image contrast is adjusted to return to the original state or the car window transparency is adjusted to return to the original state.

In accordance with some embodiments, FIG. 11 illustrates the relative positional relationship between the directional ambient-light sensor and the display. FIG. 11 is a top view of some components in a vehicle display system (e.g., the processor electrically connecting the display and the directional ambient-light sensor is not shown in the figure).

As shown in FIG. 11, a display 12 for displaying images and a plurality of directional ambient-light sensors 14 for detecting light intensities in different directions are provided below the glass cover 11. It should be noted that the plurality of directional ambient-light sensors 14 surround display 12. The installation position of each directional ambient-light sensor 14 corresponds to the angle at which the driver easily receives strong glare.

Although some embodiments of the present disclosure and their advantages have been described in detail, it should be understood that various changes, substitutions and alterations can be made herein without departing from the spirit and scope of the disclosure as defined by the appended claims. The features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps. In addition, each claim constitutes an individual embodiment, and the claimed scope of the present disclosure includes the combinations of the claims and embodiments. The scope of protection of present disclosure is subject to the definition of the scope of the appended claims. Any embodiment or claim of the present disclosure does not need to meet all the purposes, advantages, and features disclosed in the present disclosure.

What is claimed is:

1. A vehicle display system, comprising:
a display for displaying images;
a directional ambient-light sensor for detecting light intensities in different directions; and
a processor electrically connected to the display and the directional ambient-light sensor.

2. The vehicle display system as claimed in claim 1, wherein the directional ambient-light sensor is disposed adjacent to a side of the display, or disposed inside, above or below the display.

3. The vehicle display system as claimed in claim 1, wherein the directional ambient-light sensor receives light from a specific direction.

4. The vehicle display system as claimed in claim 3, further comprising a shielding layer with an opening in an oblique direction relative to the directional ambient-light sensor.

5. The vehicle display system as claimed in claim 3, further comprising an oblique collimation structure with an oblique opening disposed around the directional ambient-light sensor.

6. The vehicle display system as claimed in claim 1, further comprising a narrow-viewing-angle backlight and a wide-viewing-angle backlight disposed below the display, wherein the narrow-viewing-angle backlight and the wide-viewing-angle backlight are selectively turned on to provide light sources to the display.

7. The vehicle display system as claimed in claim 1, wherein, when the display is a self-luminous display, the display comprises a narrow-viewing-angle light-emitting unit and a wide-viewing-angle light-emitting unit.

8. The vehicle display system as claimed in claim 1, wherein there are a plurality of directional ambient-light sensors.

9. The vehicle display system as claimed in claim 1, further comprising a driver monitoring system electrically connected to the processor.

10. The vehicle display system as claimed in claim 1, further comprising a smart window system electrically connected to the processor.

11. An operation method of a vehicle display system, comprising:
detecting light intensities in different directions using a directional ambient-light sensor; and
receiving the light intensities in different directions provided by the directional ambient-light sensor via a processor to generate multiple original light intensities, weighting the original light intensities to obtain multiple weighted light intensities, and comparing the weighted light intensities or a sum of the weighted light intensities with corresponding thresholds, wherein, when one of the weighted light intensities or the sum of the weighted light intensities is greater than or equal to the corresponding threshold, a display image is adjusted to a first state, or
directly comparing the original light intensities with the corresponding thresholds, wherein the processor does not weight the original light intensities, when one of the original light intensities is greater than or equal to the corresponding threshold, the display image is adjusted to the first state, and the first state has a visual contrast that is greater than that of an original state.

12. The operation method of a vehicle display system as claimed in claim 11, wherein the processor increases a weighting proportion of intensity of incident light that is likely to interfere with a driver.

13. The operation method of a vehicle display system as claimed in claim 11, wherein, when the weighted light intensities and the sum of the weighted light intensities are both less than the corresponding threshold, there is no need to adjust the display image.

14. The operation method of a vehicle display system as claimed in claim 11, wherein the processor reduces the corresponding threshold for an intensity of incident light that is likely to interfere with a driver.

15. The operation method of a vehicle display system as claimed in claim 11, wherein the display image is adjusted by increasing brightness of a display, reducing reflectivity of ambient light, reducing brightness of ambient light reflected to human eyes, or adjusting transparency of a car window.

16. The operation method of a vehicle display system as claimed in claim 15, wherein the method of increasing the brightness of a display comprises increasing global backlight brightness, increasing local backlight brightness, increasing the brightness of a self-luminous unit, increasing transparency of a component between a display and a backlight, increasing pulse-width modulation (PWM) driving frequency, or increasing pulse-amplitude modulation (PAM) driving frequency.

17. The operation method of a vehicle display system as claimed in claim 15, wherein the method of reducing the reflectivity of ambient light comprises increasing haze of a surface of a display or reducing transparency of components placed on a display.

18. The operation method of a vehicle display system as claimed in claim 15, wherein the method of reducing the brightness of ambient light reflected to human eyes comprises adjusting an angle of a display or moving a display.

19. The operation method of a vehicle display system as claimed in claim 15, wherein the method of adjusting the transparency of a car window comprises using dimmable glass comprising dichroic dye liquid crystal (DDLC), polymer dispersed liquid crystal (PDLC), polymer network liquid crystal (PNLC), cholesteric liquid crystal (CLC), electrochromic (EC) materials, suspended particle device (SPD) chromic materials, electronic ink or photochromic (PC) materials.

20. The operation method of a vehicle display system as claimed in claim 11, wherein, after the display image is adjusted to the first state, when a driving state or an environmental state reaches an adaptive condition, the display image is adjusted to return to the original state.
